(19) United States
(12) Patent Application Publication
(10) Pub. No.: US 2015/0066592 A1
(43) Pub. Date: Mar. 5, 2015

(54) METHODS OF SEMICONDUCTOR MANUFACTURING AND SUPPLY CHAIN MANAGEMENT SYSTEMS

(71) Applicant: Infineon Technologies AG, Neubiberg (DE)

(72) Inventors: Hans Ehm, Pullach (DE); Stefan Heilmayer, Erharting (DE); Konstanze Knoblich, Assling (DE); Alexander Seitz, Muenchen (DE); Lisa Forstner, Muenchen (DE); Thomas Ponsignon, Muenchen (DE); Tim Russland, Maisach (DE)

(73) Assignee: Infineon Technologies AG, Neubiberg (DE)

(21) Appl. No.: 14/014,549

(22) Filed: Aug. 30, 2013

(51) Int. Cl. G06Q 30/02; G06Q 50/04; G06Q 50/00

(52) U.S. Cl. CPC G06Q 30/0202; G06Q 50/01; G06Q 50/04
USPC 705/7.31

(57) ABSTRACT

In various embodiments, a method of semiconductor manufacturing is provided. The method may include: gathering information impacting production of semiconductor goods via a computer network platform; gathering information from a social networking platform via an interface of the computer network platform to the social networking platform; modelling at least one agent of a manufacturing entity in carrying out its tasks to manufacture semiconductor goods; and determining manufacturing capacity of the manufacturing entity as a function of at least the gathered information impacting the production of semiconductor goods, the gathered information from the social networking platform and the modelled agent.

### TECHNICAL FIELD

This disclosure relates to systems and methods for supply chain management and, e.g., to systems and methods for semiconductor manufacturing.

### BACKGROUND

Semiconductor companies have difficulties to deliver at the expectation level of certain major customers. The customers are not satisfied by the amount of goods that a semiconductor company production/supply chain are able to commit (to deliver). Moreover, frequently customers request more volume at short notice than a semiconductor company has committed in the contract and the supply chain is able to deliver. This problem is due to the long cycle time of semiconductor products in relationship to short product life cycles of the semiconductor and the products which contains semiconductors. It is amplified due to the so-called Bullwhip effect. The Bullwhip effect is caused by the fact that a customer demand is rarely perfectly stable, and businesses should forecast demand to properly position inventory and other resources. Forecasts are based on customer inputs and statistics, and they are rarely perfectly accurate. Because forecast errors are a given, companies often carry an inventory buffer called “safety stock”. Moving up the supply chain from an end-consumer to an OEM (Original Equipment Manufacturer), Tier 1 (the first supplier to the OEM), Tier 2, . . . Tier N and the raw materials supplier, each supply chain participant usually has a greater observed variation in demand and thus a greater need for safety stock. A semiconductor manufacturer usually is a Tier 2 or higher and usually is the one with the highest cycle time and the highest own value add percentage. In periods of rising demand, down-stream participants of the supply chain will usually increase orders. In periods of falling demand, orders will usually fall or stop, thereby not reducing inventory. Thus, the Bullwhip effect is that variations are amplified as one moves upstream in the supply chain (further from the customer).

The Bullwhip effect usually is a relevant problem as approximately 350 billion (in 2011) of the world economy depends on semiconductors and it is a practical issue which was emphasized at the allocation period which followed the 2008 downturn. It is also a technical problem because much information to drastically improve a customer wish fulfillment is available, but full usage is usually technically limited.

More precisely, the information that is known to a semiconductor company about a future order picture or an ordinary forecasts may not be enough to fulfill the final customer demands, and not all that is available (or could be made available) is used at a semiconductor company at the moment.

The problem with a major customer changing order volumes or product mix on too short notice to be satisfied in a normal cycle time has been tackled in several ways so far, firstly by a conventional forecasting technique. Secondly, emergency speed-ups of production have been used. Speed-ups have also been referred to as “hot lots” and “rocket lots” which mean that these products (also referred to as lots—a lot is the manufacturing unit) requested on an emergency basis have top priority in production—overriding regular scheduling.

Other possible measures like segmentation and buffer stocks try to buffer fluctuations with stocks or try to segment the customer and products to guarantee a high fulfillment rate for the most important product customer mix.

Disadvantages of segmentation and stocks may be seen in that the base of segmentation and thus the decision on stocking points and stocking heights may change too frequently due to the described short product life cycle and the bullwhip effect so that an effective calculation may be very limited with today's techniques.

Disadvantages of relying on a conventional forecasting techniques may be seen in that they are only accurate to a certain degree. A lot of effort with limited improvements is placed so far on forecasting. Regarding speed-ups, an emergency speed-up of production is usually costly, may impact other lots in production (other customers), may increase process variability and decreases supply chain efficiency. Speed-ups may also make planning difficult for production. Due to the complex nature of semiconductor manufacturing, speed-ups are usually only possible to a certain extent. Even with these accelerations, semiconductor companies are usually still not able to deliver in some cases. Reported figures show values below 70%, but customer usually wish figures above 90% for OTD (On Time Delivery (to customers wish)). Sometimes, semiconductor companies can also not deliver due to a late recognition of problems far downstream and due to erroneous processed information.

### SUMMARY

In various embodiments, a method of semiconductor manufacturing is provided. The method may include: gathering information impacting production of semiconductor goods via a computer network platform; gathering information from a social networking platform via an interface of the computer network platform to the social networking platform; modelling at least one agent of a manufacturing entity in carrying out its tasks to manufacture semiconductor goods; and determining manufacturing capacity of the manufacturing entity as a function of at least the gathered information impacting the production of semiconductor goods, the gathered information about information from the social networking platform and the modelled agent.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a block diagram of a computer-based supply chain management system in accordance with various embodiments;

FIG. 2 shows an implementation of the computer-based supply chain management system as an on-time delivery system;

FIG. 3 shows the structure of a collaborative order management system as shown in FIG. 2;

FIG. 4 shows the structure of an advanced statistical-based forecasting tool as shown in FIG. 2;

FIG. 5 shows the structure of an option based contracts module as shown in FIG. 2;

FIG. 6 shows a process that allocates blocked stocks to customer orders which uses a stock analyzer within an aging inventory workflow;

FIG. 7 shows an illustration of the aging inventory workflow 220 in accordance with various embodiments as shown in FIG. 2;

FIG. 8 shows an overview of the segmentation tool and the surrounding system;

FIG. 9 illustrates a workflow management system according to various embodiments

FIG. 10 shows some parts which support the service based pricing concept as a portion of the option based contracts module;

FIG. 11 shows an implementation of an analysis tool;

FIG. 12 shows a method of semiconductor manufacturing in accordance with various embodiments; and

FIG. 13 shows a diagram illustrating the application of MTO, ATO and MTS to the semiconductor industry and the manufacturing and shipping thereof in accordance with various embodiments.

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

Various embodiments provide a solution to these technical problems to a great extent for supply chains, e.g. for supply chains of semiconductor products.

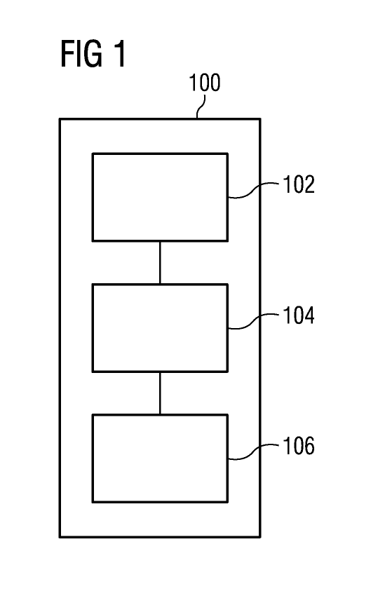

FIG. 1 shows a block diagram of a computer-based supply chain management system 100 in accordance with various embodiments.

The supply chain management system 100 may include an information collection module 102, an agent modelling module 104, and a heuristic processing module 106.

A module, as used herein, may be a unit of distinct functionality that may be presented in software, hardware, or combinations thereof. When the functionality of a module is performed in any part through software, the module includes a machine readable medium.

The information collection module 102 may be configured to gather information impacting production of semiconductor goods. The information collection module 102 may be configured to gather information from sources such as click rates on a company's internet platform, guided direct questions which may indicate later customer order behavior, and shared internal customer data, as will be described in more detail below. Click rates on a company internet platform include click rates on different pages of the company internet platform, e.g. click rates on those pages which indicate one or more products, that may be of higher interest to the customer, and thus may have a higher probability of being ordered, and thus, the click rates may be monitored by the information collection module 102, for example. Sharing the internal customer data may include setting up a secure channel in which to exchange data. Such a secure channel may be effectuated by means of a social network and/or chipcard based security system. In this way, the supply chain management system 100 may have an interface configured to gather customer order behavior from a social networking platform. Thus, in other words, sharing internal customer data may be considered as receiving confidential internal customer data from the customer via a secure “information channel”, and possibly even in an anonymized way so that the identity of the customer providing the shared internal customer data may not be disclosed to the supply chain management system 100. Furthermore, the information collection module 102 may be configured to gather information from a social networking platform (such as e.g. Facebook, Xing, LinkedIn, Research Gate, etc.) via an interface of the computer network platform to the social networking platform. In various embodiments, a social networking platform may include or provide blog sites and/or internet forums and the like.

In various embodiments, the information gathered from a social networking platform may include:
information about customer behavior;
information about the development of a market of interest; by way of example, the information may include an indication that one or more companies are doing well, which might have an impact on the behavior of the employees and thus might have an impact on the behavior of the employees within the market and thus in indirect impact on the customer behavior, for example; and the like.

The agent modeling module 104 may be configured to model one or more agents of a manufacturing entity in carrying out its or their tasks to manufacture semiconductor goods. The agent modeling module 104 may be built using various hardware and software development tools. For example, the .NET framework and an SQL Server may be used in the construction of the agent modeling module 104. Other development tools, such as Java, C++, MySQL, and/or object oriented databases may also be used in constructing the agent modeling module 104.

The heuristic processing module 106 may be configured to determine manufacturing capacity of the manufacturing entity as a function of information gathered about customer order behavior and the modeled at least one agent. The manufacturing capacity is divided and analyzed in a flexible manner based on the information collected by the information collection module 102, including, for example, customer order prediction. In order to divide and analyze the manufacturing capacity, information about subcontractors and materials suppliers may be used to optimize the manufacturing capacity. Agent and discrete simulations may, for example, be used to divide and analyze the manufacturing capacity.

The computer-based supply chain management system 100 may further include a reservation module configured to reserve semiconductor wafer or component processing. For example, dividing and analyzing manufacturing capacity may either be used directly for orders or may be used to reserve capacity for prospective orders or to ensure capacity for a given customer.

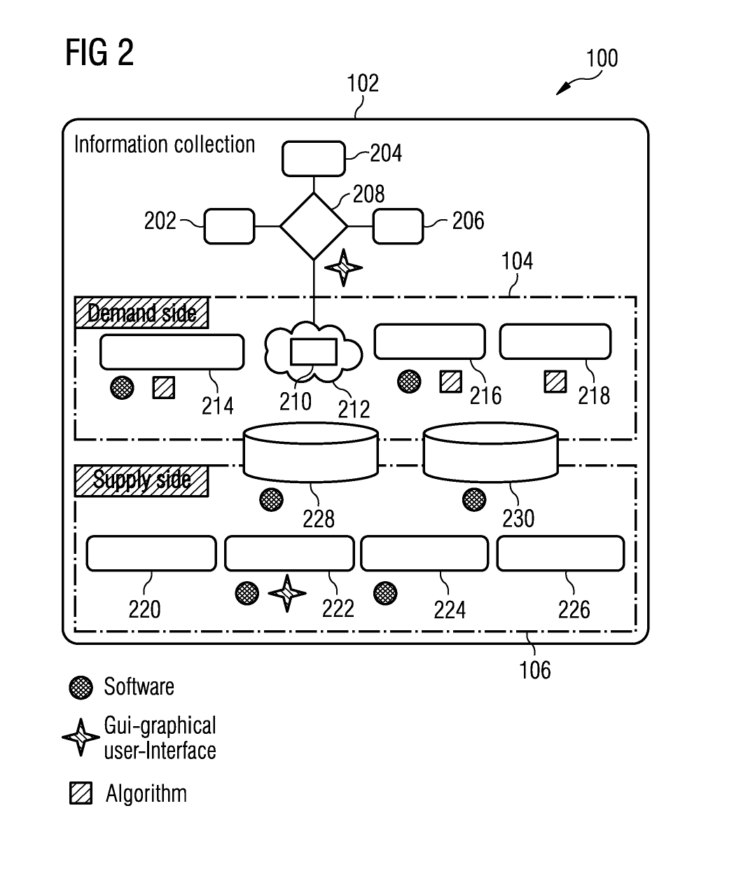

As will be described in more detail below, the computer-based supply chain management system 100 may be implemented as an on-time delivery system 100 (OTD system), the structure of which is shown in more detail in FIG. 2 and will be described in more detail below.

The OTD system 100 may solve the problem of not being able to deliver a product due to frequent short-notice changes in order behavior and order forecasting in two ways.
Firstly, the OTD system 100 increases the amount of information known about customers' and market situation. This is done through a network platform (working name “cloud+”) that is arranged primarily between the semiconductor company and its customers (but also between the semiconductor company and its suppliers and its various production partners (as shown in FIG. 2), which will be described in more detail below. Secure information exchange (e.g. of the shared internal customer data) and collaboration may be enhanced, which may lead to an increase in overall knowledge. This knowledge may enable the semiconductor company to “know what the customer will order sometimes even before he knows it”, in other words to better predict demand of customers. Specifics regarding the type of information will be presented in the next section. Technically, this network platform may features a chipcard-based security solution to enable secured freedom of communication (anonymous where deemed necessary) between the semiconductor company and its partners. The gathered additional information may be stored on a database and may enable the semiconductor company to have a better picture of demand than what is achievable with known forecasting techniques (since these cannot use this additional information when generating forecasts). Examples of the shared internal customer data may include: delayed or accelerated milestones of customers product development containing semiconductor in progress, perception of gaining or losing market share, perception of trends relevant to customer products containing semiconductors.
Secondly, the OTD system 100 may make better use of the information conventionally available—and the information generated by enhanced collaboration (e.g. by appreciation and awarding valuable information) and communication through the network—by placing or providing more intelligence internally at the semiconductor company. This intelligence may be achieved through the use of several enablers; a collaborative and an option based order management system, advanced statistical-based forecasting and an inventory/stock management system to increase the flexibility, it features SC SPC (supply chain statistical process control) an advanced Delivery Early Warning process and an aging inventory workflow, for supply warnings and sanity checks and an agent-based simulation to continuously enable improvement changes on the implemented solutions and for robustness checks as well as iWoMan (Infineon Workflow Management software), for example, to bridge the gap between the individual “best of breed” IT Software Tools. All these will be further described on the next sections.

More available information together with a higher ability to use the information may result in reduced necessary production speed-ups, reduced negative impact on other lots/other customers, decreased process variability, increased supply chain flexibility.

FIG. 2 shows an implementation 100 of the computer-based supply chain management system 100 as an on-time delivery (OTD) system 100.

The OTD system may illustratively include a plurality of e.g. three portions, e.g. the information collection module 102, the agent modelling module 104, and the heuristic processing module 106, as already described above.

The information collection module 102 may be configured to collect information e.g.:
From customers (e.g. by means of a customer information collection module 202):
This customer information may be collected as collaborative customer information. As previously described, OTD 100 may increase the amount of information available to a semiconductor company about their customers' future needs. An optionally provided cloud computer arrangement (e.g. Cloud+) supply chain portal may enable customers to, with anonymity if desired, share information with the semiconductor company that was conventionally kept private. This may be enabled with a chipcard security solution. The chipcard security solution may mean that customers can be certain that the data that they enter is, depending on the customer's choice, completely anonymous (the semiconductor company will e.g. only know that the customer information originates from a customer, but not, which customer or who entered the customer information). The customer may, however, only need to know that the information will stay within the semiconductor company, in which case the semiconductor company will also need to authenticate to access the information. These requirements are achieved through a database where different users are only able to view certain aspects of all data. It should be noted that the database may be an external database to prevent the semiconductor company holding anonymous data. As an alternative, the database may be an internal database. In turn, the access to the database may be granted with a USB (Universal Serial Bus) “dongle” (removable device to authenticate the user), through a password or through the new german “Personalausweis” or equivalents in other countries being used together with an identity scanner. One or more of these possible ways of authenticating may be provided in various embodiments.
From external suppliers & partners (e.g. by means of an external supplier information collection module 204):
The type of information that is to be entered into the cloud (e.g. Cloud+) network may indirectly describe a future demand of semiconductor company products, beyond simply the amount of products that the customer wished to order in the future. This could be information such as delayed milestones at the customer (will mean delayed ordering of semiconductor company products). The customer may, however, not wish (as he may put himself in a worse negotiation position) to change the order of semiconductor company products yet through the official forecast channels. With OTD, the resulting reduced demand for semiconductor company products may be determined faster than if the semiconductor company would wait until a respective customer changes the order. The opposite is true with a milestone that has been achieved earlier than a respective customer originally intended.
From a Semiconductor Company's internal supply (e.g. by means of a semiconductor company information collection module 206):
Illustratively, the information may be collected from access to semiconductor company's databases.
The (improved) information regarding demand from customers may be derived by using web analytics e.g. on the semiconductor company's packaging and technical product webpages. In this case, the amount of clicks or the amount of web activity that is associated with each single product page may be detected and may be used to derive a nominal demand or a change in a demand (from nominal or change in web activity). A learning machine (e.g. based on pattern recognition using support vector machines) may be provided which may be configured to continuously update a process to derive demand information from web analytics. More web applications (beyond packaging and technical products) may be provided in various embodiments. This information may e.g. be gathered from the company's website of the company which is collecting the information and/or from a distributor's website.

It is to be noted that in various embodiments, any kind of additional information that may result in a change of the demand of semiconductor company products, but does not warrant an immediate change in the customer order, may be provided and entered into the computer cloud 212 (e.g. Cloud+).

The gathered information from these components may be stored in a memory 208, which may e.g. be a secured memory 208. The secured memory 208 may include or be implemented by means of a chipcard based secured platform 208.

The gathered or collected information may be provided by the memory 208 to a central server 210, which may be part of a computer cloud 212.

Furthermore, the agent modelling module 104 (which may also be referred to as a ‘demand side’ module 104) may include a collaborative order management system 214, an advanced statistical-based forecasting tool 216, an option based contracts module 218 and as already mentioned the computer cloud (e.g. implemented as Cloud+) 212.

Moreover, the heuristic processing module 106 (which may also be referred to as a ‘supply side’ module 106) may include the following building blocks: an aging inventory workflow 220, an SPC (statistical process control) circuit 222 for supply chain data, a segmentation/stock management system 224 and an advanced delivery early warning process 226.

The above mentioned components of the agent modelling module 104 and the heuristic processing module 106 may be interlinked with each other via an analysis and advanced workflow based tool 228, e.g. a tool called iWoman 228. Further, to simulate inside the company supply chain and the interaction between agents in the end-to-end supply chain, an agent-based simulation software 230 may be provided.

In various embodiments, the various components (also referred to as building blocks) of the OTD system 200 may illustratively provide added intelligence in data analysis that may provide a benefit for OTD (another advantage may be increased amount of information).

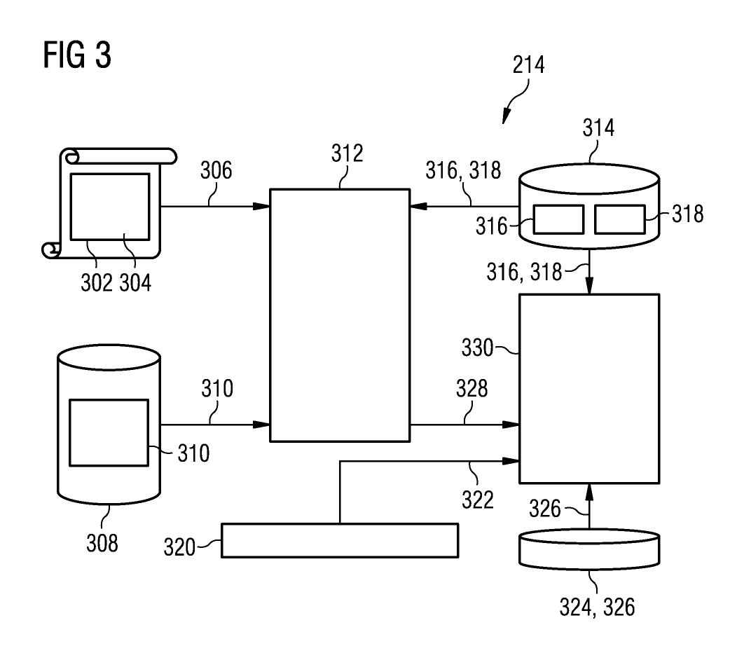

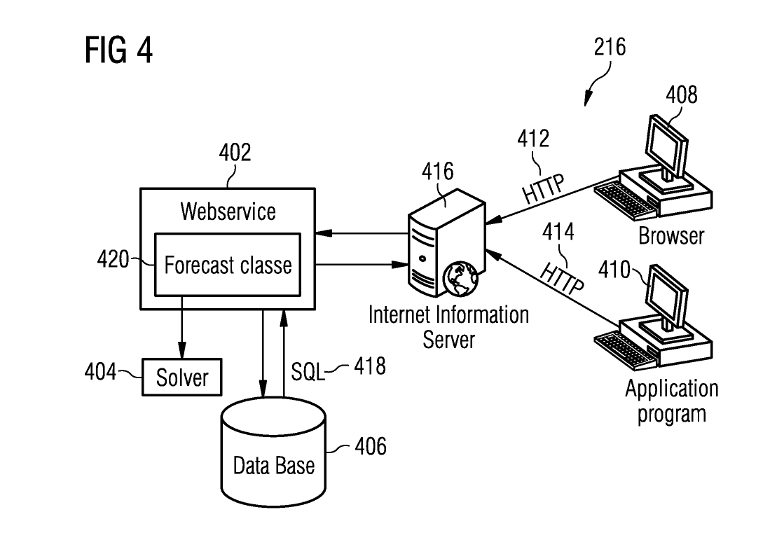

In the following, various implementations of some of the building blocks of the OTD system 200 will be described in more detail.
Collaborative order management system 214:
The collaborative order management system 214 may enable the semiconductor company to efficiently and quickly handle orders. With added information from the computer cloud 212, the collaborative order management system 214 may further enable the semiconductor company to handle complex ordering behavior. The collaborative order management system 214 may be fed with information from the computer cloud 212 and may synthesize it with a pre-existing order picture. This may result in a more accurate picture of orders and potential orders than previously available.
Various aspects of this collaborative order management system 214 may be seen in that it may be configured to separate order confirmation towards the customer from requests to the supply chain system in a transparent and audit-confirmed way. Thus, various embodiments may go beyond a graphical user interface (GUI) for changing the customer demand. The customer may only be changed if there are audit confirm reasons to enable changing the demand. For example, if a customer always orders 10% (+/−2%) less than he forecasts (he has a confirmed bias of at least +8%), the collaborative order management system 214 may suggest to reduce the demand for the internal supply chain by 8% despite committing the whole forecasted volume towards the customer. Other, additional or similar but more complex rules or algorithms may be used in various embodiments, e.g. when several customers for one product are involved, for seasonal effects and for ramp ups and ramp downs and option contracts (see building block option based contracts module 218). The robustness of the applied heuristics may be confirmed via simulations (see e.g. building block agent-based simulation software 230).
An overview of the collaborative order management system 214 is shown in FIG. 3. The collaborative order management system 214 may include seven portions, for example.
a) A first portion 302 may be referred to as an open order book module 302. The open order book module 302 may store a confirmed date/wish data and a order placement date/wish date 304, and thus, the open order book module 302 may be configured to extract and provide the confirmed date/wish data together with the associated order placement date/wish date, a client's history of order changes and information concerning specific products and alternate products that a customer is interested in, e.g. as open order book data 306, e.g. to a supply agreement violation check module 312 which will be described in more detail below.
b) A second portion 308 may be a supply agreement database 308 in which a minimum purchasing quantity, a lead time, a price of a product, a maximum difference WD/CD (Wish date to confirmed date) etc. may be stored as possible supply agreement data 310 and thus may be retrieved and provided to the supply agreement violation check module 312.
c) The data retrieved from the open order book module 302 and the supply agreement database 308 may be combined and checked in a third portion 312, which may also be referred to as a supply agreement violation check module 312. The supply agreement violation check module 312 may be configured to provide violation flags, latest allowed delivery dates, (newly) confirmed dates, shippable alternatives etc, which may also be referred to as supply agreement violation check data 328. Within the supply agreement violation check module 312, different measurements to analyse contract compliance may be used, e.g. an order lead time measurement which compares the time between a customer's first order entry date and the customer's requested delivery date from the open order book 302 with the agreed order lead times from the contract database 308. The result out of this measurement, being compliant or not compliant, may be transferred as the supply agreement violation check data 328 to an order promising engine (solver and/or heuristics) 330 for further actions.
d) A different input source to check if there is a violation of the supply agreement may be a price/allocation database 314 (fourth portion 314). The price/allocation database 314 may mainly store and be configured to provide pricing rules 316 for supply agreement violations for each customer and also customer segmentation data 318.
e) A fifth portion 320 may also be referred to as a demand/supply match module 320. One input for the demand/supply match module 320 may be demand information that contains e.g. demand forecasts established by one or more marketing and sales departments for certain customers or customer classes (a plurality of customers may be grouped into various customer classes in accordance with predetermined criteria taking into account the characteristics of the respective customers), as well as demand forecasts directly given by the customer and firm orders on hand. A second input for the demand/supply match module 320 may be information on the currently available gross resources (e.g. capacities or work in progress) in the supply chain. On basis of the two inputs described above, the demand/supply match module 320 may calculate a feasible production plan on a rather detailed level for the whole supply chain by booking demand into available gross supply chain resources. This production plan may be, on the one hand, forwarded to the production planning processes of the supply chain planning process where it may further be detailed and enriched with data provided to actually produce the products needed. On the other hand, the output of the demand/supply match module 320 may be used to calculate a so called supply picture 322 that may also be referred to as available to promise supply for order promising (as an option, the supply picture 322 may also be determined by the demand/supply match module 320 and may be output by the demand/supply match module 320, e.g. to the order promising engine (solver and/or heuristics) 330. The algorithms implemented for demand/supply match may be of heuristical or optimal nature—depending on the problem size and the desired/necessary level of optimality of the solution.
f) A sixth portion 324 which may also be referred to as the master database (Log DB) 324 may store and thus be configured to provide product master data and a seller hierarchy 326.
g) Supply agreement violation check data 328 provided by the third portion 314, the pricing rules 316 for supply agreement violations for each customer and the customer segmentation data 318 provided by the price/allocation database 314 (the fourth portion 314), the supply picture 322 provided by the demand/supply match module 320, and the product master data and seller hierarchy 326 provided by the master database 324 may be gathered and combined in a seventh portion 330, which may also be referred to as the order promising engine (solver and/or heuristics) 330. The order promising engine 330 is configured to calculate an initially promised delivery date for an order newly coming into the system. Furthermore, the order promising engine 330 checks the feasibility of already confirmed delivery dates on a regular or event driven basis for every open customer order in the system. The promising engine 330 may therefore apply an optimal solution method or a heuristic. The algorithms used here may consume supply of the requested products or their substitutes by searching through all dimensions of available supply (e.g. time, customer segment, seller hierarchy) and reserving supply for the orders. The order promising engine 330 thus prioritizes profitable orders considering contractual obligations and the customers' preferences provided within the orders. While performing the feasibility check for already confirmed open orders, the order promising engine 330 may also be configured to seek to improve the current confirmation date toward the preferred delivery date of the customer. The output of the processes that take place inside the order promising engine 330 may be (1) initial promises for incoming orders and (2) repromised delivery dates, positive (possible improvement of order confirmation dated) and negative (possible delay of order confirmation date) early warnings and contract violation warnings.
Advanced statistical-based forecasting tool 216:
The advanced statistical-based forecasting tool 216 may implement as such conventional statistical-based methods for (customer) demand forecasting and may only use past order picture(s) as input to generate forecasts. Conventional statistical based forecasting methods may not be appropriate for the semiconductor industry (short life cycle, high market volatility and the like). With enhanced statistical-based forecasting, a future order picture may be used as well. In other words, in various embodiments, a customer demand forecast may be determined using one or more statistical-based methods and the manufacturing capacity may be determined taking the determined customer demand forecast into consideration.
In various embodiments, an alpha*information from the past+(1−alpha) information from the future may be used to determine the forecast(s). The weighting alpha may be set using an optimization function that strives for minimizing a forecast error applied to historical data (backwards optimization). A part related to past information may involve a broad range of conventional statistical functions, e.g. exponential smoothing (a weighting technique based on billings and forecast from past periods, incorporating the increasing influence of more recent data), Holt-Winter method (an extension of exponential smoothing by including both trend and seasonality components), Book-to-Bill (a technique where the forecast is based on the ratio between customer orders and billings from the past). The Book-to-Bill approach can be formalized as the customer orders for the current period divided by the customer orders in the past, multiplied by the billings from the past. The Book-to-Bill approach provides a demand forecast for the current period.
A meta-technique may also be used to select the most appropriate forecasting technique on a case-by-case basis for a customer and product segment. The parameters may be so adjusted, that the curve of forecast coincides as far as possible with the curve of orders. This advanced statistical forecasting method may be used for each specific product (applying multiple forecasting methods on single products and selecting the most accurate forecast). The so-called Symmetric Mean Absolute Percentage Error (SMAPE) formula may be used as an accuracy measure. The SMAPE formula produces performance values between 0 (worst) and 100 (best). Periods with a huge demand have a larger influence on the accuracy than periods with a small demand. The “Symmetric” in SMAPE stands for the fact that an x-fold over estimation of the demand quantity is regarded as relatively equal performing compared to an x-fold under estimation. For example, a two-fold over estimating forecast of 200 units is valued with a SMAPE of 67 when the actual demand quantity is 100 as well as a two-fold under estimating forecast of 50 units. This performance measure may be used for forecast accuracy calculations at semiconductor company.
The general principle of the advanced statistical forecasting methods implemented in the advanced statistical-based forecasting tool 216 may imply that for each product and each period of time, all implemented forecast techniques may be applied on the past data. A spreadsheet model may be provided which may be configured to collect data, solve the nonlinear optimization problem, and carry out the forecasts. Then, the performance of each technique may be measured by using the SMAPE formula. The Visual Basic programming language and the Solver within a speadsheet. A spreadsheet may be used to automate the workflow as much as possible. Using the Solver with the spreadsheet environment may have the advantage to provide a user-friendly interface even for users, which are not technically highly skilled. Furthermore, the built-in statistical and graphical capabilities of the software can be used to prepare various kind of reports based on the raw data and on the forecasts. The best forecast technique may selected for each product and then applied for the demand forecast of the next periods. For example when for a certain product and customer class it turned out that in the past periods using 60% (alpha=0.6) of historical data and 40% of future data deliver the best forecast accuracy measured with SMAPE and a demand smoothing of historical data (60%) turned out that one month old historical data should be weighted by 50%, 2 month old by 25% etc. then those data are used to predict the future demand for this customer and product segment.
The computer cloud 212 (e.g. Cloud+) may increase the available information for the statistical based forecasting system and thus a better forecast and a better OTD (On Time Delivery) may be achieved.
FIG. 4 shows the structure of the advanced statistical-based forecasting tool 216 as shown in FIG. 2 in more detail. The advanced statistical-based forecasting tool 216 may be implemented as a webservice application 402. The advanced statistical-based forecasting tool 216 may provide a browser 408 or a dedicated application program 410 symbolized in FIG. 4 by means of computer terminals. Thus, the user may use the browser 408 or the dedicated application program 410 to initiate a forecast generation or to request performance measure values, e.g. via a respective communication connection 412, 414 (e.g. a respective hypertext transfer protocol (HTTP) communication connection 412, 414) with a server 416, e.g. an internet information server 416, which may be connected to or have implemented the webservice application 402. The webservice 402 may be linked to a solver 404 that may be configured to perform a parameter fitting/setting/optimization. A database 406 may be used to store information according to product hierarchy, input data and output data. The data exchange 418 between the database 406 and the webservice 402 is using an ODBC (Open Database Connectivity) protocol and SQL (Structured Query Language). The webservice 402 may be programmed using the SQL language. The solver 404 is based on the solver Solver Platform SDK version 7.1 Frontline Systems. The webservice application 402 may work in the following manner:

1. Needed data (e.g. orders, forecasts, manual forecasts) may be loaded on a regular basis, e.g. on a weekly basis into the database 406 that is linked to the webservice application 402 via the (e.g. SQL) connection 418.

2. The database 406 may be structured according to a data model, which may include or consist of several tables for input data, output data, time aggregation/disaggregation, product hierarchy, and customer information, for example.

3. Once the upload of the data is completed, the webservice application 402 may be configured to trigger a program, e.g. a so-called “forecast class” 420, that may initiate one forecasting process or a plurality of forecasting processes, which are implemented in the forecast class 420, for all products contained in the database 406.

4. The program, e.g. the forecast class 420, may read the data from the data base 406 and may generate the forecasts. The different forecasting methods, e.g. those as described before, may be applied and may be implemented in the forecast class 420. The solver 404 may be provided to perform a parameter fitting/setting/optimization of the one or more forecasting methods implemented in the forecast class 420. The generated forecasts (including the quality class of this forecast—e.g. with 90% accurate within a defined range) may be stored in the table for output data in the database 406.

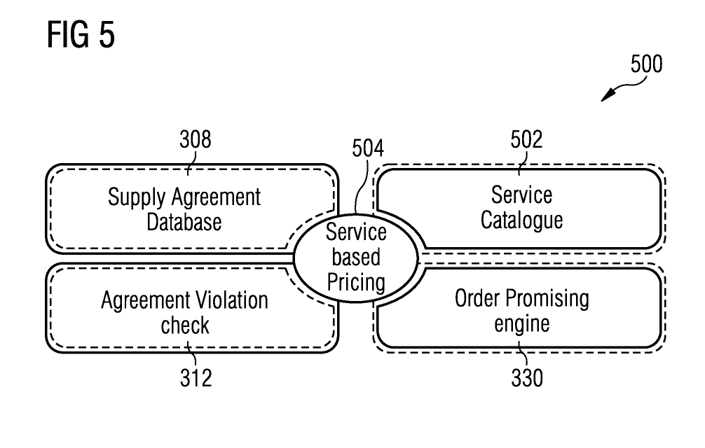

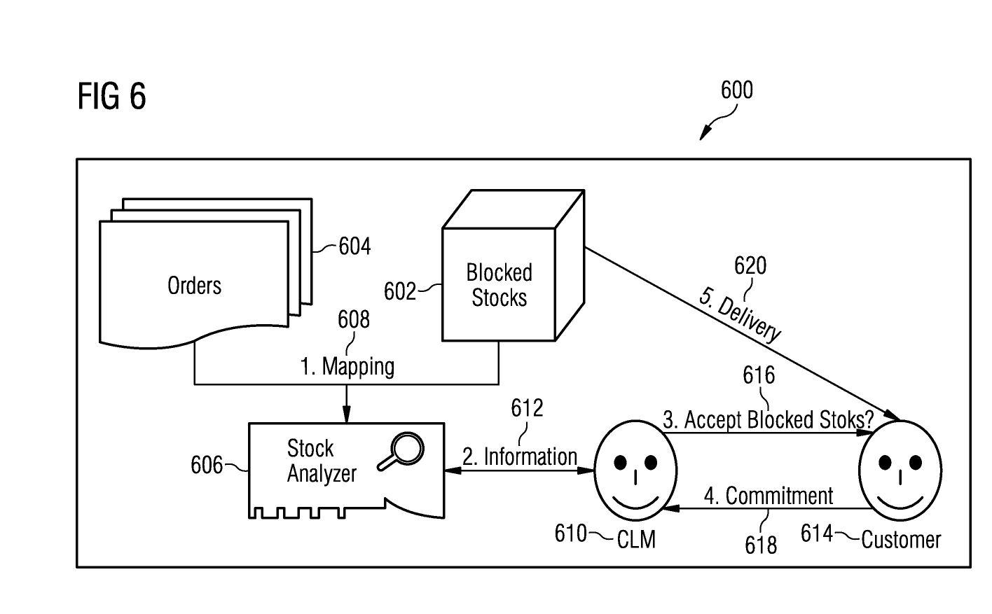

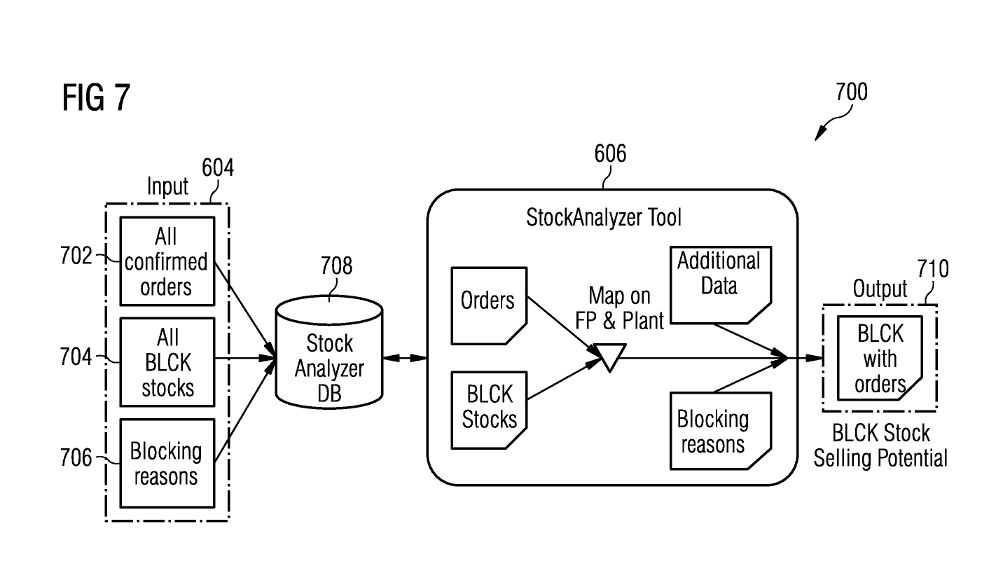

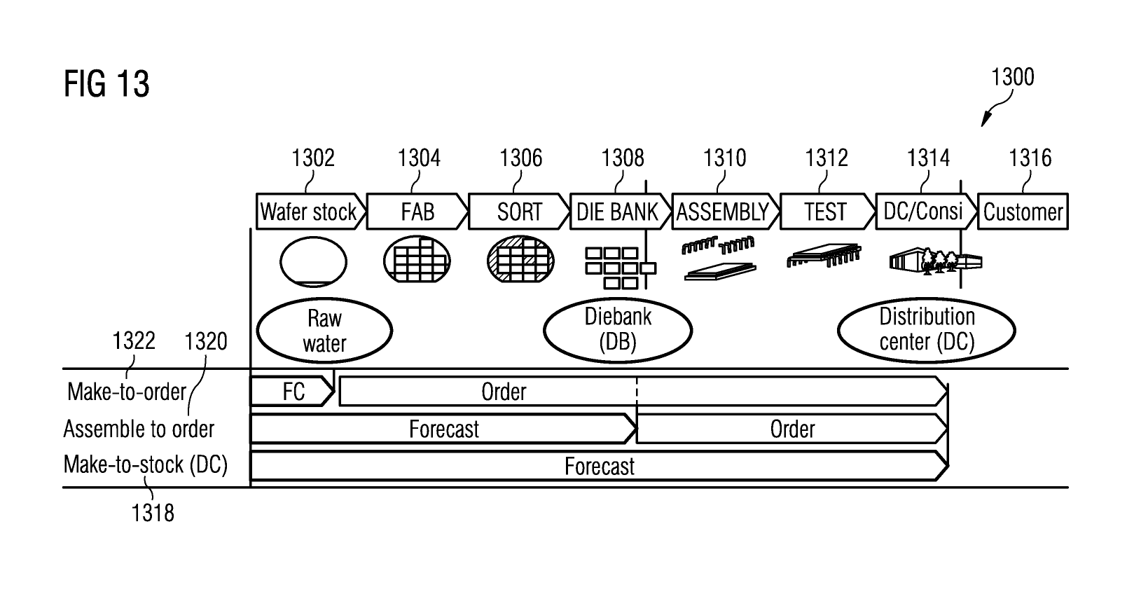

5. Moreover, the user may trigger an “on-demand” forecast generation for a given set of products, and for a given aggregation level. The selection of products may be done via the browser 408 or the application program 410. The request is transferred from the browser 408 or the application program 410 to the webservice application 402, e.g. via the internet information server 416.
Option based contracts module 218:
Sharing of forecast information between buyer and seller may be necessary in the semiconductor industry, but it alone may not be sufficient to manage effectively the demand volatility. Game-playing is as such common: customers inflate their demand forecasts to ensure the semiconductor manufacturer builds enough capacity, while the manufacturer plans conservatively to avoid overcapacity and to stay cost competitive. This behavior may result in tight supply and allocation difficulties for the manufacturer, and also downtime and lost revenue for customers.
Flexibility based and options based contracts with service based pricing may be provided and used. This may enable customers to buy “insurances” to “reserve capacities” to trigger the buildup of stocks or to buy additional services, like shorter order lead times. A segmentation to customers and lead-times may offer different services at different prices. This concept is somewhat similar to the revenue management approach as applied in the airline, hotel and car rental industry where it has been proven valid. However, applying these concepts in the process industry at the complex and volatile semiconductor industry needs additional features as the primary focus of this concept is not to sell products on the highest possible price as in the service industry, but to align demand peaks and off-peaks, therefore additionally to standard supply agreements, a service based pricing may be provided. Furthermore, the characteristics of a B2B (business-to-business) relationship and different customer negotiation powers may be considered. The four main parts to implement this concept may be seen in the supply agreement database 308, the agreement violation check 312, the service catalogue and the order promising engine 330.
Based on the service catalogue, the customer may decide which services he wants to add to his negotiated standard contract, which could be for example flexibility or option based contract. In the flexibility based contract, the forecast and ordering process may start with the customer forecast demand provision to the supplier. The customer forecast may contain the information about the requested delivery date and the needed quantity of a product. The latter will check if the provided demand forecast is an initial or updated demand forecast of a previous version in the order promising engine 330. The contract clauses from the supply agreement database 308 will be applied on the updated demand forecast and based on the output of the agreement violation check 312 a decision made to decline or accept the customer update. In the option contract model, the buyer decides how much options he wants to buy for a certain delivery window, a certain period before the first scheduled delivery date in the chosen delivery window. The supplier will reserve manufacturing capacity via the order promising engine 330 equal to the amount of options purchased in order to meet aggregated demand for the delivery window. For each option, the customer has to pay an option price and for each exercised option an exercise price. If the customer does not exercise all purchased options for a certain delivery window, the option price may serve as a compensation fee for the seller who will incur production cost for these options. The non exercised options may be transferred to the spot market. In the case where the buyer's demand exceed his options, he can buy additional products on the spot market for a certain price assuming that the spot market has available products. In addition to these contracts, the customer may order services for individual orders. These services may be listed in a service catalogue which provides for example services related to production acceleration, emergency shipments or additional short term flexibility.
In various embodiments, the method may thus include determining a manufacturing capacity offer for a customer based on the determined manufacturing capacity. Illustratively, the manufacturing capacity offer (e.g. a price or a tupel including a number of products and the price for this amount, or a bundle offer including a number of different products and the respective prices) may be determined taking into account the previously determined manufacturing capacity of the one or more manufacturing entities. Furthermore, the respective contract(s) between the manufacturer and the customer may be taken into account when determining the manufacturing capacity offer.
FIG. 5 shows some parts which support the service based pricing 504 concept as a portion of the option based contracts module 218 in a block diagram 500: The supply agreement database 308, the agreement violation check 312, a service catalogue 502 and the order promising engine 330. The supply agreement database 308 provides the information on what basic services the customer and the supplier agreed (e.g. contract flexibility). The agreement violation check 312 provides the information, what services the customer would need. For example a negative output of the agreement violation check 312 would make it visible if the customer requests on a frequent basis shorter order lead times than agreed in the basic contract. Based on the service catalogue 502, the right service could be offered to the customer in order to improve his order flexibility. If the customer buys additional services, the order promising engine 330 will apply this service accordingly to the customers order.
Aging inventory workflow 220:
The aging inventory workflow 220 may be provided as an additional source of added information. When inventory becomes old, it may be a good indication that this product is not in demand/needed any more. By extending this aging inventory workflow 220 with gathering information towards customers, it may enable the semiconductor company to get more information from customers about their future wishes. This again may be used to increase the ability to deliver what the customer wishes.
Besides gathering information about future customer wishes, the aging inventory workflow 220 may help connecting the orders with stock that is blocked for automatic delivery, e.g. because it is outdated for a certain period of time and therefore a special clarification with the customer is needed.
FIG. 6 shows a process 600 that allocates blocked stocks 602 to customer orders 604 which uses a tool called a stock analyzer 606. When new orders 604 come in, the stock analyzer 606 analyzes and connects the orders 604 with blocked stocks 602 of the same products. This process 600 is also called ‘mapping’ 608. Next, the gathered information about customer orders 604 and matching blocked stocks 602 may be shared with a customer logistics manager 610 (which may also be referred to as CLM—Customer Logistics Manager)) (symbolized in FIG. 6 by a double arrow 612). The CLM 610 may be in direct contact with customers 614 and may check if the blocked stocks 602 are suitable for the specific customers 614. After the initial internal check the customers 614 may be informed and asked for acceptance of the blocked stocks (symbolized in FIG. 6 by an arrow 616). Depending on commitments 618 the customers 614 made with the CLM 610, blocked stocks 602 may be used for fulfilling the customer's demand (symbolized in FIG. 6 by a delivery arrow 620).
FIG. 7 shows an illustration 700 of the aging inventory workflow 220 in accordance with various embodiments. As shown in FIG. 7, the new orders 604 may include various types of information such as e.g.
some or all confirmed orders 702;
some or all blocked stocks 704; and
blocking reasons 706.
Furthermore, a stock analyzer 708 may be provided, into which the new orders and thus the above various types of information may be input and stored. For an easier explanation, the following situation is assumed: Stocks may get blocked when there are restrictions, which do not allow to sell these stocks to all customers. Blocked stocks 704 (BLCK stock) may not be sold automatically in a planning system which may be an SAP system but may still be a valuable stock. A high risk of scrapping may exist when no action is triggered to sell the BLCK stock 704 manually. But it may be difficult to identify the stocks having orders. Thus, in various embodiments, the stock analyzer 606 may be configured to map existing orders 604 with BLCK stocks 704 and to offer additional information like blocking reasons. Input data to the stack analyzer database 708 as well as to the stock analyzer 606 may e.g. be all confirmed orders 702, BLCK stocks 704 and the blocking reasons 706. The orders 604 and stocks may be mapped on the finished product (FP) and on the plant to only show sellable potential 710. When a customer accepts the BLCK stocks 704, a customer logistics manager 610 can deliver these stocks instead of a regular supply.
SPC (statistical process control) circuit 222 for supply chain data:
As such conventional systems may enable semiconductor company to view critical supply chain data and KPI (key performance indicators) on a single screen. Input data may be from several systems within the semiconductor company supply chain, such as Stock levels, Order picture and delivery performance. For example if the orders for a certain customer and product segment are always at 100+/−10)1 sigma) in a certain time period and now there are some strongly above that it is a trigger for information, but also if the average goes up or down. Statistics enable to distinguish between noise and information. This method usually applied in semiconductor manufacturing where a single wafer fab is monitored by hundred thousands of so called control charts with cp, cpk values and action trigger limits will eb used for supply chain processes here—some might say the supply chain becomes the new global fab.
By use of dynamic sampling algorithms in semiconductor company's manufacturing processes combined with a dynamic control strategy for estimating defect inspection capacity, it may be possible to improve the rate of quality controls without increasing the material at risk in production.
The SPC for supply chain data and KPIs go beyond that as statistical methods for control charts (usually applied in advanced manufacturing systems) are applied to the supply chain and both supply deviations and order deviations are detected early before they appear (example when the oxide thickness is on the upper corner and lithography line width is on the extreme plus (but both still within the spec) the probability that the RDSON (Leckstrom) is high increases, and thus a yield drop is expected). This information may be used to predict earlier as conventionally possible a lower yield and thus a lower supply.
Segmentation/stock management system 224:
Software (and/or hardware) and corresponding algorithm may improve the inventory/stock management system 224 at semiconductor company. Input data may be current stock levels, production lead times, delivery performance, historic demand, product specific data, the product life cycle including detailed ramp up information, the order picture and the forecast. As the forecast may be improved with OTD also the benefit of the new inventory/stock management system 224 will increase.
Current inventory systems are too static for the dynamic semiconductor market. Conventionally, the main focus is on the calculation of safety stocks using a defined service level but without given recommendations how the service level should be changed according to the current capacity restrictions e.g. when there is not enough capacity to fill up the safety stocks or if there is free capacity available. Similar topics are addressed in the food processing industry but the algorithms may be different and may be adapted to the semiconductor industry. This new system targets a better customer satisfaction for Semiconductor industries as well as cost optimization via a time dependent segmentation of products into Make-to-Order (MTO), Assembly-to-order (ATO) and Make-to-Stock (MTS) products with varying service levels according to the capacity situation. A much higher flexibility is the result and thus a much higher OTD. How MTO, ATO and MTS are applied to the semiconductor industry and the manufacturing and shipping thereof is shown in a diagram in FIG. 13. The manufacturing and shipping processes in the semiconductor industry may include one or more of the following processes, which may be carried out one after the other:
Providing a raw wafer from a wafer stock (block 1302);
Carrying out the front-end-of-line (FEOL) processes and the back-end-of-line (BEOL) processes to manufacture a plurality of chips or dies on or in a wafer (block 1304);
Sorting the manufactured plurality of chips or dies (block 1306);
Arranging a plurality of chips or dies on a die bank (block 1308);
Assembling the one or more chips or dies (block 1310);
Testing the assembled one or more chips or dies (block 1312);
Providing the tested assembled one or more chips or dies to a distribution center (block 1314); and
Shipping the tested assembled one or more chips or dies from the distribution center to a customer (block 1316).

Products may be produced forecast-driven until they are completely finished in case of MTS 1318. In case of ATO 1320, products may be produced forecast-driven until the point right before it comes to the assembly. Starting from there, the production may continue based on a customer order. The MTO 1322 strategy may be characterized by a pure order-driven production.

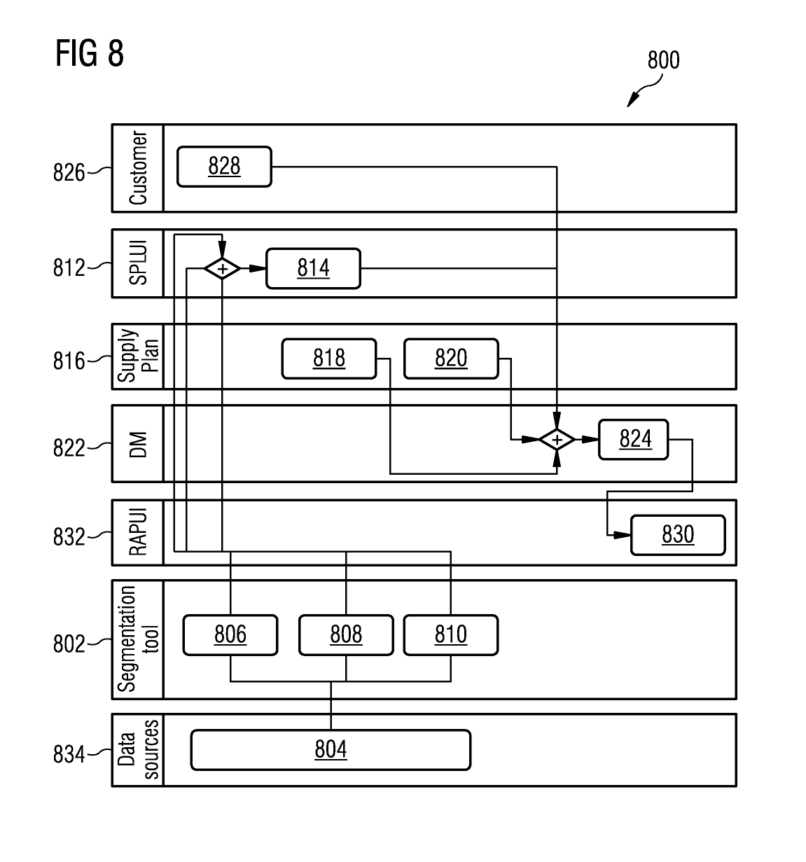

FIG. 8 shows an overview of a segmentation tool 800 and the surrounding system.

As shown in FIG. 8, an overview 800 of the segmentation tool 802 is shown. The segmentation tool 802 may be surrounded by different parts such as data sources 834, from where data like; customer priority, production lead time, historic data of ordering behavior, end application of product to determine market stability and needed service level, available capacity, product diversification, gross margin, turnover, service level and production utilization may be gathered (block 804). The gathered data may serve as an input for the segmentation tool 804. The segmentation tools 804 may then define a strategy 806 for each product as described in the part above. Other functions of the segmentation tool 802 may be defining a safety stock 808 and defining a minimum stock 810.

An aspect of the segmentation tool 802 may be a dynamic segmentation into the stocking points with a hysteresis. This means the entry criteria for a product to reach a lower downstream stocking point (e.g. make to stock) are tighter that the go back to a less downstream stocking point (assemble to order). With this approach, stability on the one hand and immediate reaction for larger changes is achieved which is a novum for supply chains in the volatile semiconductor environment.

The output of the three processes with the segmentation tool 802 is then passed on to the SPLUI (supply planning user interface) 812, where the outputs for the segmentation tool 802 (safety stock, minimum stock, strategy) may be combined with SCP (supply chain planner) forecasts 814.

From the supply plan 816, additional information may be gathered concerning; Inventory on DC (Distribution Centre) and DB (Die bank, where the processed not yet assembled wafers are stored for future diversification in various packages), and WIP (Work In Progress) 818, together with information concerning the available capacity 820.

A DM (demand manager) 822 may be configured to combine information from the SPLUI 812, the supply plan 816, the DM 822 and customer data 826 like entered orders and forecasts 824 in order to match demand and supply 828. Once the demand and supply 828 are matched the production request 830 in the RAPUI (request and promise interface—the final commit tool) 832 may be sent.
Advanced delivery early warning process 226:
On the operational level of the planning process of supply chain management, order promising and order confirmation are exemplary functions of demand management, where companies aim to match supply with concrete customer's orders over time. At semiconductor company order confirmations are based on predicted supply out of a supply chain. Because of possible changes in either predicted supply or customer's orders, order confirmations are checked and reconfirmed daily.
In the advanced delivery early warning process 226, deviations/fluctuations in prospective supply picture and their possible effects on order confirmations may be detected and corrected by the order management system before they can actually negatively influence the result of the semiconductor company. The process may have several sub-processes, such as:
1) First, early warnings may be issued by the order management system if during periodical reconfirmation step orders cannot be re-promised on the date they have been confirmed before. A negative early warning (nEW) may be issued when there is not enough supply for an order to meet the current confirmed material availability date (CMAD=date when goods arrive at a distribution center ready to be packed and shipped to the customer).
2) Secondly, an assessment if the early warning is caused by a supply problem, an order related or an IT (information technology) issue. Afterwards, a root cause for the early warning will be eliminated or action to solve the problems may be taken. Consequently the CMAD may be postponed to a date according to which the ordered goods can be delivered to the customer.
The advanced delivery early warning process 226 is not only important for the actual delivery early warnings within the company and towards the customer, it may also enable a “sanity check” that all other building blocks in OTD work well and the base data system reflects the real world.
Analysis tool 228, e.g. a tool called iWoman 228:
In various embodiments, a best-of-breed IT tool may be provided. A conventional problem is that consistency may be lost if one goes from one system to another. iWoMan is solving this topic. This software closes information gaps when information is exchanged across system (Tool) borders. It may also provide other functions such as monitoring, controlling and documentation. By way of example, this system may not have information from the computer cloud 212 (e.g. Cloud+) as input, but may enable information between the computer cloud 212 (e.g. Cloud+) and the other building blocks to be exchanged, controlled and documented efficiently. Therefore, it may be provided within the OTD concept.

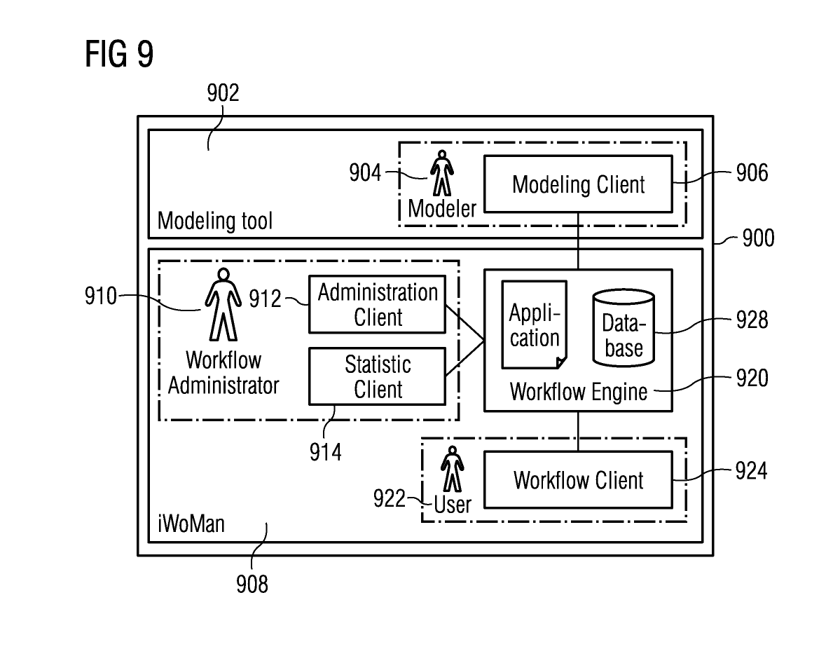

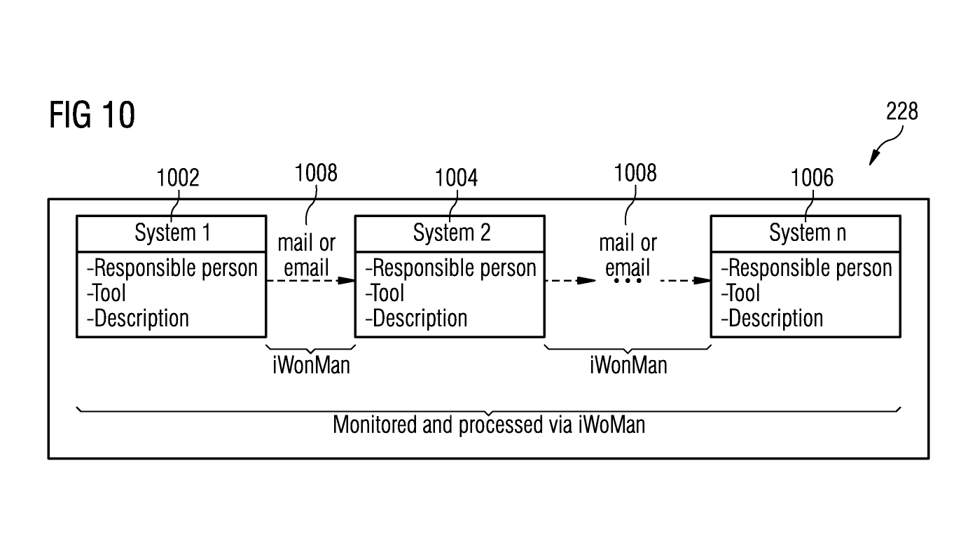

FIG. 9 illustrates a workflow management system 900 according to various embodiments. It is noted that the workflow management system 900, as depicted, may be modified to effectively fit the needs and existing systems and practices of a given company. In the depicted workflow management system 900, there may be two major tools: a modeling tool 902, and an internal workflow management tool 908 (e.g. iWoMan). The modeling tool 902 may encompass a modeling client 906, and a modeler 904 to interact with the modeling client 906. With the modeling client 906, model descriptions of work processes may be created and provided. This may be managed by an external application and does not have to be included in the workflow management system 900. In this way, the modeler 904 may be either a local user, or an application program interface (API) with an external application. Further, the modeling tool 902 may be connected with the internal workflow management tool 908 with an interface provided by the internal workflow management tool 908.
The workflow management system 900 may have three clients which are connected via interfaces with the core of the system, e.g. the workflow engine 920. The design and functions of these clients are described in further detail below. These clients may include: an administration and monitoring client 912, a workflow client 924, and a statistic client 914.
In addition to the tools and clients there may be three different roles which are responsible for operating these tools. These roles are depicted with stick-figures 904, 910, and 922. Because of the complexity of process modeling, administration, and monitoring of processes and the processing of process flows it may be provided to assign the responsibility to different roles in the workflow management system 900.
The process modeler role 904 may be responsible for modeling processes and may need to be very familiar with the modeling notation used for modeling processes as well as with the modeling client in use. In addition to possessing knowledge in the modeling language and tool, it may be important for the process modeler 904 to understand the details of the process to be modeled in order for process modeler 904 to be able to effectively model the given processes.
For effectiveness, the administrator 910 should also have a good understanding about the processes and models of the company and the system, since the administrator 910 may serve in a sensitive role. That is, the administrator role 910 may be capable of adding execution information to processes and may be responsible for resolving the roles within the process model. Moreover, with the administration client 912, it may be possible to start or abort processes. If the wrong process is mistakenly aborted, the system may be damaged. Thus, the administrator role 912 should be delegated to a limited group of persons with defined qualification.
The user role 922 may provide a simple user interface that allows the use of the workflow client 924 without significant formal training. Since the user role 924 is likely to encompass a wide group of users, the workflow client 924 may provide clear instructions for successful processing.
Turning now to specific details of the modeling client 906, the modeling of processes should be done by the process modeler 928 using the modeling client 906. In order to support a process with the workflow management system 900, there may be a formal, machine readable process description. Formal modeling languages generally have a strict set of vocabulary and rules. Thus, a process description formulated with a formal modeling language is not ambiguous and can be read with preciseness. Because of the set of rules and vocabulary that a formal modeling language provides, the modeler 904 may generally have to be trained in understanding the formal modeling language. In addition to understanding the formal modeling language, the modeler 904 may also have to understand how to create a process model using modeling client 906.
Various modeling languages exist which may be used to model a process as required by workflow management system 900. Generally speaking, the various modeling languages may be categorized into: graphical notations, and execution languages. Various workflow management systems 900 may use a graphical notation to create process models and visualize them for the users. To be able to execute these graphical models, however, they may be mapped to an execution language which is machine readable by the workflow engine 920. Some examples of graphical notation may include: event-driven process chain (EPC), and business process modeling notation (BPMN).
Illustratively, in various embodiments, modelling at least one agent of the manufacturing entity in carrying out its tasks to manufacture semiconductor goods may include modelling at least one manufacturing process in a machine readable process description for the workflow management system 900.
While some examples of execution language may include: Web Service-Business Process Execution Language (WS-BPEL), XML Process Definition Language (XPDL), Event-driven Process Chain (EPC).
FIG. 10 shows a block diagram illustrating an implementation of the analysis tool 228, e.g. a tool called iWoman 228.

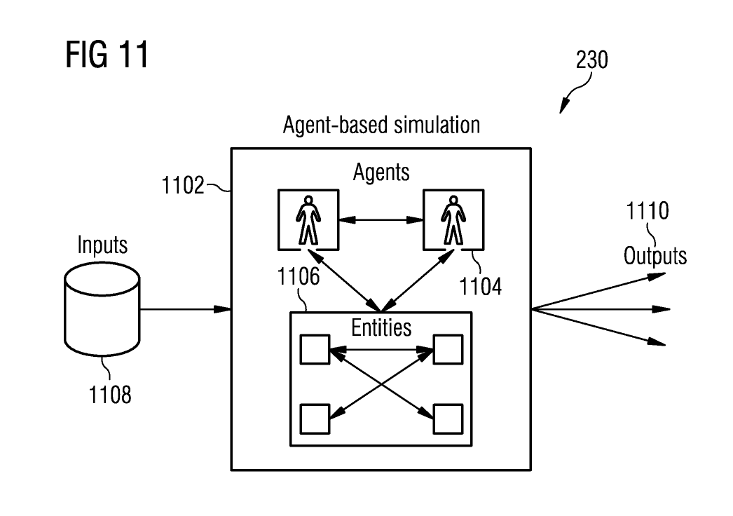

At a semiconductor company there are many cross-system processes. Already existing tools are used to support each system, but there are gaps in the communication between the systems. The communication between the responsible persons/systems might be slow and unreliable for example. And usually there is no monitoring which covers the whole process. iWoMan covers these gaps and enables a reliable communication between the systems and responsible persons as shown in FIG. 10. It is also possible to have an overview over the status of the whole process. Basically, iWoMan solves the gaps of cross system processes. A cross-system process may include several systems 1002, 1004, 1006. For each system 1002, 1004, 1006, there may be defined responsible persons and tools and descriptions which support the use of each system 1002, 1004, 1006. In cross system processes (1) information may be shared between the systems 1002, 1004, 1006. In various embodiments, this communication may (e.g. only) be based on mail or email 1008. This may not be reliable because emails or mails 1008 can get lost or the communication partner might be unknown. To support a reliable communication iWoMan may be provided to standardize and document the communication between each system 1002, 1004, 1006, by predefined recipients and messages. In cross system processes more than two systems 1002, 1004, 1006, may be involved in a process (2). In general, it may be difficult for every participant to have an overview over the whole process because not every participant might be informed about each process step. iWoMan may provide an overview over the whole process for every participant. At every time it may be possible to see which process is currently getting processed and to get information about the following processes. This is possible by defining the whole process flow in the so-called BPMN (Business process modeling notification) process model and documenting the information about the closure of every single process step (like a check list).
Agent-based simulation software 230:
In a conventional system, a simulation containing human behaviors have rarely been used for defining an order management system, defining heuristics and stocking levels, but human behaviors may change the results drastically. The bullwhip effect (see explanations above) may be derived from human behavior like risk aversion. The use of agent-based simulation software 230 to simulate the interaction between agents in the end-to-end supply chain (from customer's customer to supplier's supplier) may be the first base.
One goal of agent-based simulation software 230 may be to increase understanding on how certain actions by the semiconductor company and by the suppliers and customers will affect the supply chain. The added information from the computer cloud 212 (e.g. Cloud+) may function as input to SC simulation models.
The results may be a contribution to the derived heuristics for the order management systems, the audit conform test of those heuristics and ensuring robustness (in the production area) of those heuristics.
FIG. 11 shows the structure of the agent-based simulation software 230 as shown in FIG. 2 in more detail.

The agent-based simulation part may e.g. include two parts:
A first part may include commercially available simulation software 1102, which supports agent based 1104 as well as discrete event simulation.

A second part may include a specific simulation model 1106 of the remaining building blocks of this disclosure. The latter one means, that the main objects, roles (agents) and processes (connections) of the other building blocks may be represented in the model. This may allow optimizing continuously the whole OTD solution, which may be provided to adapt to changed environment behavior and circumstances, i.e. inputs 1108, for example. The simulation allows testing and analyzing the effect of changing input parameters to the model (which may be equal to those for the OTD solution). By doing such experiments in varying parameters, which can be influenced by the company, it may be possible to select the best strategy, the best heuristics or best decision before changing anything in the real OTD solution (i.e. outputs 1110, for example) and this may ensure that the OTD solution optimizes itself. This saves time and money and allows probing many more scenarios than it would be possible in reality.

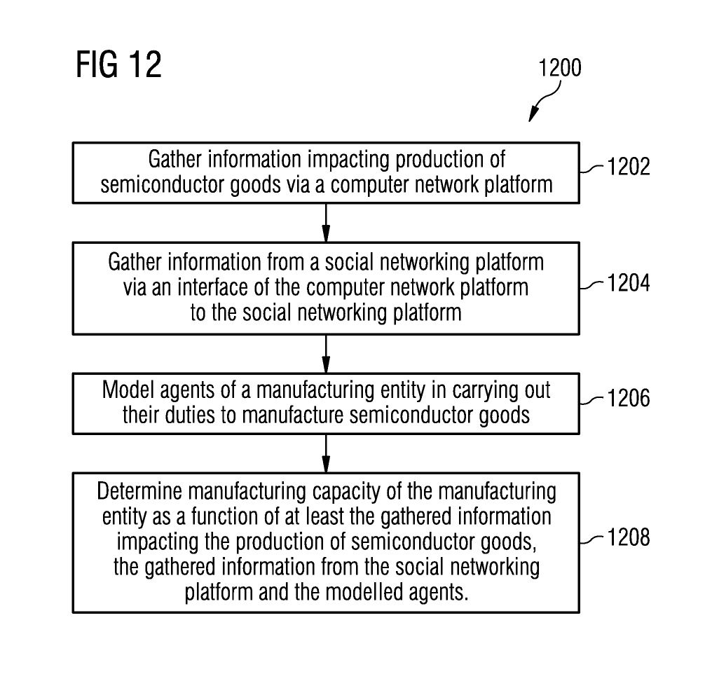

FIG. 12 shows a method 1200 of semiconductor manufacturing in accordance with various embodiments.

The method may include, in 1202, gathering information impacting production of semiconductor goods via a computer network platform, and, in 1204, gathering information from a social networking platform via an interface of the computer network platform to the social networking platform. The method 1200 may further include, in 1206, modelling one or more agents of a manufacturing entity in carrying out its of their tasks to manufacture semiconductor goods, and, in 1208, determining manufacturing capacity of the manufacturing entity as a function of at least the gathered information impacting the production of semiconductor goods, the gathered information from the social networking platform and the modelled one or more agents.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A method of determining manufacturing capacity of a manufacturing entity for semiconductor manufacturing, the method comprising:
gathering information impacting production of semiconductor goods via a computer network platform;
gathering information from a social networking platform via an interface of the computer network platform to the social networking platform;
modelling at least one agent of the manufacturing entity in carrying out its tasks to manufacture semiconductor goods; and
determining manufacturing capacity of the manufacturing entity as a function of at least the gathered information impacting the production of semiconductor goods, the gathered information from the social networking platform and the at least one modelled agent.

2. The method of claim 1, further comprising:
adapting manufacturing capacity according to the determination.

3. The method of claim 2,
wherein adapting manufacturing capacity comprises reserving semiconductor wafer processing.

4. The method of claim 2,
wherein adapting manufacturing capacity comprises placing an order for a supplier.

5. The method of claim 2,
wherein adapting manufacturing capacity comprises modifying at least one work schedule of at least one worker of the manufacturing entity.

6. The method of claim 1,
wherein the platform configured to gather information from the social networking platform includes an interface to provide secure communication between the customer and the platform.

7. The method of claim 6,
wherein the interface to provide secure communication between the customer and the platform includes a chipcard-based security system.

8. The method of claim 1, further comprising:
providing an interface to the platform configured to gather information about at least one of suppliers; customers and partners.

9. The method of claim 1, further comprising:
inventorying pre-manufactured stocked goods; and
determining manufacturing capacity of the manufacturing entity as a function of at least the inventorying.

10. The method of claim 9, further comprising:
prioritizing pre-manufactured stocked goods based on shelf-age; and
fulfilling customer orders with pre-manufactured stocked goods by priority.

11. The method of claim 1, further comprising:
providing an interface to the platform configured to interact with the modelling of the at least one agent in the manufacturing entity.

12. The method of claim 1, further comprising:
determining a manufacturing capacity offer for a customer based on the determined manufacturing capacity.

13. The method of claim 1, further comprising:
determining a customer demand forecast using one or more statistical-based methods;
wherein the manufacturing capacity is determined taking the determined customer demand forecast into consideration.

14. The method of claim 1, further comprising:
wherein the gathering information impacting production of semiconductor goods via a computer network platform comprises gathering statistical process control data.

15. The method of claim 1,
wherein modelling at least one agent of the manufacturing entity in carrying out its tasks to manufacture semiconductor goods comprises modelling at least one manufacturing process in a machine readable process description for a workflow management system.

16. A computer-based supply chain management system, comprising:
an information collection module configured to gather information impacting production of semiconductor goods, the information collection module comprising an interface configured to gather information from a social networking platform;
an agent modelling module configured to model at least one agent of the manufacturing entity in carrying out its tasks to manufacture semiconductor goods; and
a heuristic processing module configured to determine manufacturing capacity of the manufacturing entity as a function of information gathered from the social networking platform and modelled agent.

17. The supply chain management system of claim 15, further comprising:
a reservation module configured to reserve semiconductor wafer processing.

18. The supply chain management system of claim 15, further comprising:
an interface to provide secure communication between the customer and the platform.

19. The supply chain management system of claim 15,
wherein the interface to provide secure communication between the customer and the platform includes a chipcard.

20. A non-transitory computer readable medium having computer-executable instructions of performing a method of determining manufacturing capacity of a manufacturing entity for semiconductor manufacturing, the method comprising:
gathering information impacting production of semiconductor goods via a computer network platform;
gathering information from a social networking platform via an interface of the computer network platform to the social networking platform;
modelling at least one agent of a manufacturing entity in carrying out its tasks to manufacture semiconductor goods; and
determining manufacturing capacity of the manufacturing entity as a function of at least the gathered information impacting the production of semiconductor goods, the gathered information from the social networking platform and the modelled agent.

21. The non-transitory computer readable medium of claim 20,
wherein the method further comprises:
inventorying pre-manufactured stocked goods; and
determining manufacturing capacity of the manufacturing entity as a function of at least the inventorying.
